(19) United States
(12) Patent Application Publication
(10) Pub. No.: US 2021/0191464 A1
(43) Pub. Date: Jun. 24, 2021

(54) ELECTRONIC DEVICE WITH EXTENSIBLE DISPLAY SCREEN AND CONTROL METHOD THEREFOR

(71) Applicant: HuiZhou TCL Mobile Communication Co.,Ltd., Huizhou (CN)

(72) Inventors: Xingchun CHEN, HuiZhou (CN); Bin LUO, HuiZhou (CN); Fan HUANG, HuiZhou (CN); Yuxiong LEI, HuiZhou (CN); Shengfang QIU, HuiZhou (CN); Xu WANG, HuiZhou (CN); Zhuwei QIU, HuiZhou (CN)

(73) Assignee: HuiZhou TCL Mobile Communication Co.,Ltd., Huizhou (CN)

(21) Appl. No.: 16/621,695

(22) PCT Filed: Dec. 18, 2017
(86) PCT No.: PCT/CN2017/117029

§ 371 Date: Dec. 12, 2019

(30) Foreign Application Priority Data
Jun. 13, 2017 (CN) 201710443721.3

(51) Int. Cl. G06F 1/16

(52) U.S. Cl. CPC G06F 1/1649; G06F 1/1669; G06F 1/1652

(57) ABSTRACT

An electronic device with an extensible display screen and a control method therefor. The electronic device includes: a mobile terminal (10), a protective sleeve (20), and a keyboard (30) and an auxiliary display screen (40) for communicating with the mobile terminal (10) respectively. The keyboard (30) and the mobile terminal (10) are arranged on the protective sleeve (20). The auxiliary display screen (40) is arranged on the other side opposite to a main display screen of the mobile terminal (10). The front and back sides of the mobile terminal (10) may simultaneously carry out display with provision of the auxiliary display screen (40), and thus the electronic device is applicable to a variety of user scenarios. Additionally, a corresponding display may be selected according to different display content of the mobile terminal (10) so as to obtain a better display effect.

### BACKGROUND OF INVENTION

### Field of Invention

The present invention relates to a technical field of electronic devices, and more particularly, to an electronic device with an extensible display and a control method therefor.

### Description of Prior Art

Two-in-one tablets in daily life are mainly integrated for entertainment and office use, and cannot only meet the demands from entertainment sector, but also for basic office tasks. With a two-in-one tablet display in fixed orientation, to show content in a tablet to others requires turning the display to others, which may be user unfriendly during watching. Of course, a user may watch the display together with others from the same direction, but this is very inconvenient because everyone is crowded together in front of a small screen, and it is difficult to meet everyone's viewing requirements in large audience scenarios.

### SUMMARY OF INVENTION

The invention is sought to solve technical problems and overcome shortcomings of existing technology, and provides an electronic device with an extensible display and a control method therefor.

For the above-mentioned objective, the present invention employs the following technical schemes.

An electronic device with an extensible display, comprising a mobile terminal, a protective sleeve, and a keyboard and an auxiliary display for communication with the mobile terminal respectively, the keyboard and the mobile terminal are arranged on the protective sleeve respectively, and the auxiliary display is arranged on a side opposing to a main display of the mobile terminal, thus to realize a dual display function of the mobile terminal and improve user experiences.

Further, the keyboard is provided with a first thimble which is operable to connect to a communication port of the mobile terminal using wireline connections to improve communication signaling.

Further, the mobile terminal is equipped with a power switch used to switch on and off the auxiliary display.

Further, the protective sleeve comprises a front cover, a first rear cover and a flexible part, wherein the flexible part is connected with the front cover and the first rear cover, and the first rear cover is rotatable relative to the front cover, the keyboard is arranged on an inner surface of the front cover, the mobile terminal is arranged on a surface of the first rear cover facing the front cover.

Further, the auxiliary display is arranged on a surface of the first rear cover facing away from the front cover.

Alternatively, the auxiliary display is arranged on the back of the mobile terminal, and a window is formed on the first rear cover, and the auxiliary display is arranged in the window.

A control method for an electronic device with an extensible display, comprising:

detecting whether a mobile terminal is in a communication state with a keyboard;

detecting whether a power switch is in a triggered state and determining whether duration of the triggered state reaches a preset value, and, when the duration reaches the preset value, selectively switching on or off an auxiliary display according to the detected communication state regarding the mobile terminal and the keyboard.

Further, the detecting as to whether the mobile terminal is in the communication state with the keyboard further comprises:

detecting signal level of a communication port on the mobile terminal, wherein if the signal level of the communication port is high, the mobile terminal is in a communicationally connected state with the keyboard.

Further, the auxiliary display is electrically connected to the keyboard and is disposed on a protective sleeve, and the auxiliary display on an outer surface of the first rear cover is switched on when the mobile terminal is detected to be in the communicationally connected state with the keyboard, as well as when duration for which the power switch is in a triggered state is detected as reaching the preset value.

Alternatively, the auxiliary display is electrically connected with the mobile terminal and disposed on the back of the mobile terminal, the auxiliary display on the back of the mobile terminal is switched on when the mobile terminal is detected as being in a communicationally disconnected state with the keyboard, as well as when duration for which the power switch is in a triggered state is detected as reaching the preset value, and a screen of a main display is transferred to the auxiliary display.

The invention discloses an electronic device with an extensible display and a control method therefor, by adding an auxiliary display on the other side of the mobile terminal, the front and back sides of the mobile terminal can be utilized for display simultaneously, which is suitable for multi-user scenarios, on the other hand, according to the different display contents of the mobile terminal, a specific display can be selected to obtain better display results.

### BRIEF DESCRIPTION OF THE DRAWINGS

FIG. 1 is a structural view of an electronic device of a first embodiment of the present invention.

FIG. 2 is a flowchart of a control method for an electronic device of the first embodiment of the present invention.

FIG. 3 is a flowchart of another control method for an electronic device of the first embodiment of the present invention.

FIG. 4 is a structural view of an electronic device of a second embodiment of the present invention.

FIG. 5 is a schematic view showing a combination of a mobile terminal and an auxiliary display of the second embodiment of the present invention.

FIG. 6 is a flowchart of a control method for an electronic device of the second embodiment of the present invention.

### DETAILED DESCRIPTION OF PREFERRED EMBODIMENTS

In order to manifest the purposes, technical schemes and advantages of the present invention, the present invention is further detailed with drawings and embodiments in the following description. It should be understood that specific embodiments described herein is used only to explain the present invention and not intended to limit the present invention.

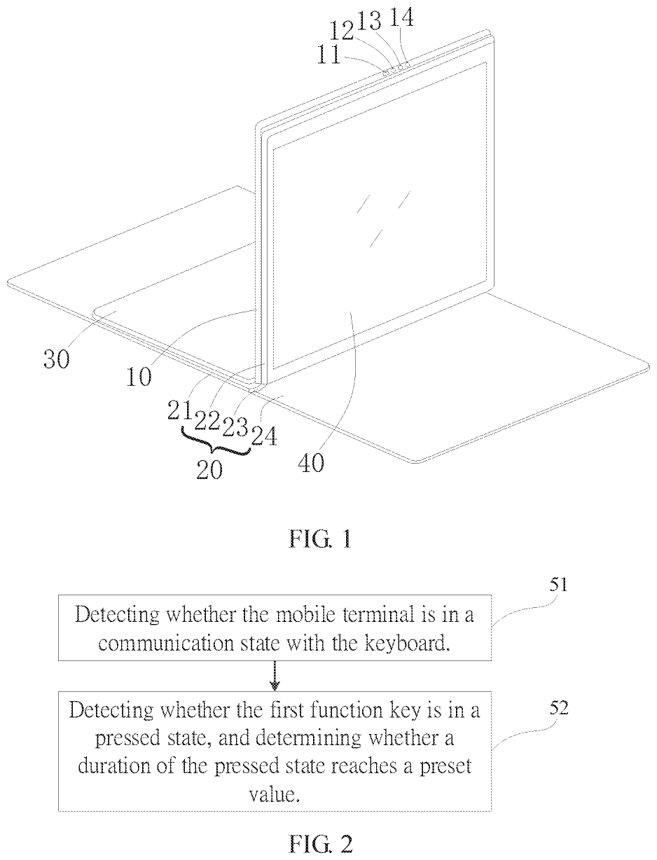

As shown in FIG. 1, an electronic device with an extensible display of an embodiment of the present invention includes a mobile terminal 10, a protective sleeve 20, a keyboard 30, and an auxiliary display 40. The mobile terminal 10 establishes communication with the keyboard 30 through a wireless connection or a wired connection. The mobile terminal 10 and the keyboard 30 are disposed on the protective sleeve 20 respectively. The auxiliary display 40 is disposed on the other side of the mobile terminal 10 opposing to a main display of the mobile terminal 10, and is in communication with the mobile terminal 10, enabling transferring of a screen on the main display to the auxiliary display 40.

Some specific embodiments are given in the following for detailed description of the technical scheme of the present invention.

### First Embodiment

As shown in FIG. 1, the protective sleeve 20 comprises a front cover 21, a first rear cover 22, and a flexible part 23. The flexible part 23 connects the front cover 21 and the first rear cover 22, so that the first rear cover 22 is bendable to be in a certain supporting angle relative to the front cover 21. The keyboard 30 is disposed on an inner surface of the front cover 21. The mobile terminal 10 is disposed on a surface of the first rear cover 22 facing toward a surface of the front cover 21. This further enables the mobile terminal 10 to establish a communication connection with the keyboard 30 through a wired connection. Specifically, a first thimble is disposed on a side of the keyboard 30 close to the mobile terminal 10, and a communication port is disposed at a position of mobile terminal 10 corresponding to the first thimble. When the mobile terminal 10 is placed on a corresponding position of the keyboard 30, the first thimble is inserted into the communication port to realize communication therebetween. A detection circuit in connection with the communication port is equipped in the mobile terminal 10. When the first thimble is connected to the communication port, the detection circuit identifies that a signal level of the communication port is high.

Further, the auxiliary display 40 is located on a surface of the first rear cover 22 of the protective sleeve 20 facing away from the front cover 21, and the auxiliary display 40 is electrically connected to the keyboard 30, thus realizing the communication between the auxiliary display 40 and the mobile terminal 10. The protective sleeve 20 also includes a second rear cover 24 in connection to the flexible part 23, and the second rear cover 24 is on an outer side of the first rear cover 22. When the protective sleeve 20 is closed, the second rear cover 24 covers the auxiliary display 40 for protection.

In other embodiments, a second thimble is disposed on the back of mobile terminal 10 to achieve an electrical connection between the auxiliary display 40 and the mobile terminal 10. A through hole is formed on a position on the first rear cover 22 corresponding to the second thimble. The second thimble is in an electrical connection with a corresponding interface on the auxiliary display 40 through the through hole.

Further, as shown in FIG. 1, a power switch 11 and a plurality of physical keys are disposed on a side of the mobile terminal 10. The power switch 11 in the embodiment is a button switch. The physical keys include a first function key 12, a second function key 13, and a third function key 14. The power switch 11 is used to switch on and off the auxiliary display 40. The first function key 12, the second function key 13, and the third function key 14 are respectively used to enable a forward page turning function, a backward page turning function, and a return function of the auxiliary display 40. In alternative embodiments, the power switch 11 may be a touch switch.

As shown in FIG. 2, a control method for an electronic device with extensible displays in the embodiment of the present invention includes the following:

In step 51, detection is performed as to whether the mobile terminal 10 is in a communication state with the keyboard 30.

Specifically, a signal level on the communication port of the mobile terminal 10 is detected. When the signal level is high, the first thimble is electrically connected to the communication port, then the mobile terminal 10 is in a communicationally connected state with the keyboard 30. When the signal level is low, the first thimble is disconnected form the communication port, then the mobile terminal 10 is in a communicationally disconnected state with the keyboard 30.

In step 52, detection is performed as to whether the power switch 11 is in a triggered state, and determination is performed as to whether duration of the triggered state reaches a preset value. When the duration reaches the preset value, the auxiliary display 40 is selectively switched on or off according to the detected communication state of the mobile terminal 10 and the keyboard 30. For example, the preset value is set to 5 seconds.

Specifically, when the power switch 11 is selected as a key switch, detection is performed as to whether the power switch 11 is in a pressed state, and determination is performed as to whether duration of the pressed state reaches the preset value. When the duration reaches the preset value, the auxiliary display 40 is selectively switched on or off according to the detected communication state of the mobile terminal 10 and the keyboard 30. Alternatively, when the power switch 11 is selected as a touch switch, detection is performed as to whether the power switch 11 is in a pressed state, and determination is performed as to whether duration of the pressed state reaches the preset value. When the duration reaches the preset value, the auxiliary display 40 is selectively switched on or off according to the detected communication state of the mobile terminal 10 and the keyboard 30.

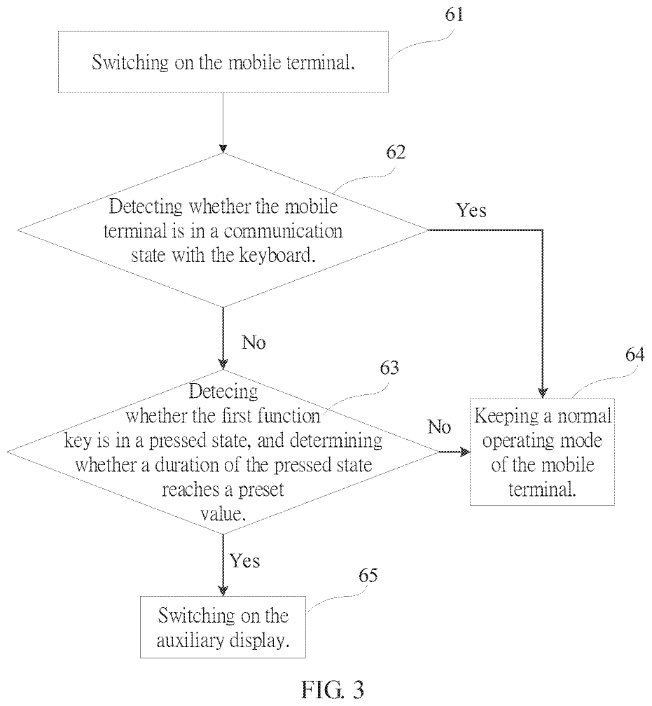

Specifically, as shown in FIG. 3, the mobile terminal 10 is switched on, and then detects a communication state between the mobile terminal 10 and the keyboard 30. When the mobile terminal 10 and the keyboard 30 are in a communicationally connected state, a display mode of the mobile terminal is maintained. When the mobile terminal 10 and the keyboard 30 are in a communicationally disconnected state, detection is performed as to whether duration for which the power switch 11 is in the triggered state reaches the preset value. When the preset value is not reached, a display mode of the mobile terminal is maintained. When the preset value is reached, the auxiliary display 40 on the surface of the first rear cover 22 is switched on, and a screen of the main display is transferred to the auxiliary display 40.

The electronic device of the embodiment is suitable for a multi-user scenario. For example, when a user needs to share display with others, rather than having to separate the mobile terminal 10 and the keyboard 30, the user triggers the power switch 11 for duration of the triggered state reaching the preset value, thus to transfer the screen of the main display to the auxiliary display 40 on the surface of the first rear cover.

### Second Embodiment

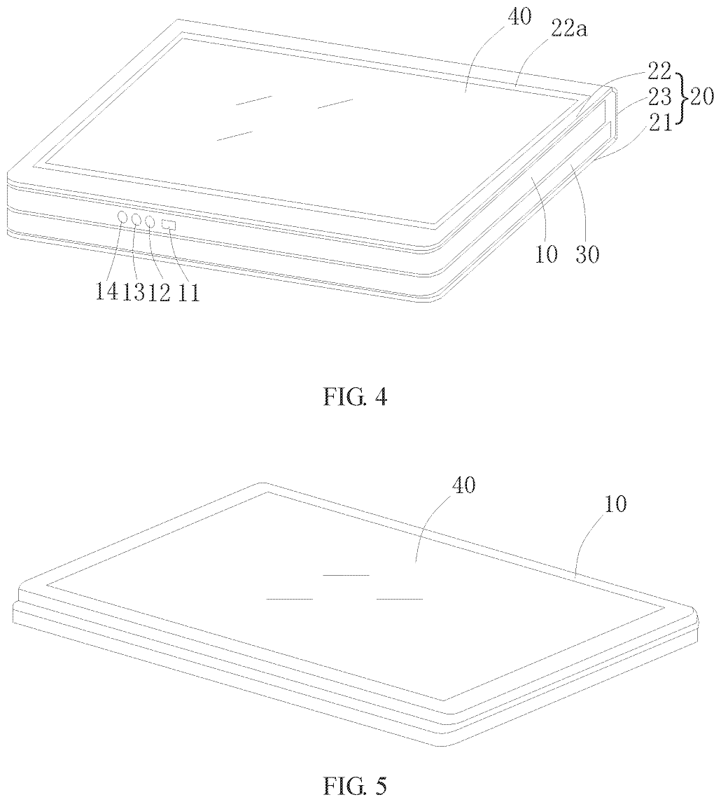

As shown in FIG. 4 and FIG. 5, what is different from the first embodiment is that the auxiliary display 40 is disposed on the back of the mobile terminal 10, and the auxiliary display 40 is electrically connected to a circuit board in the mobile terminal 10. The protective sleeve 20 comprises the front cover 21, the first rear cover 22, and the flexible part 23, and the auxiliary display 40 is attached to an inner surface of the first rear cover 22.

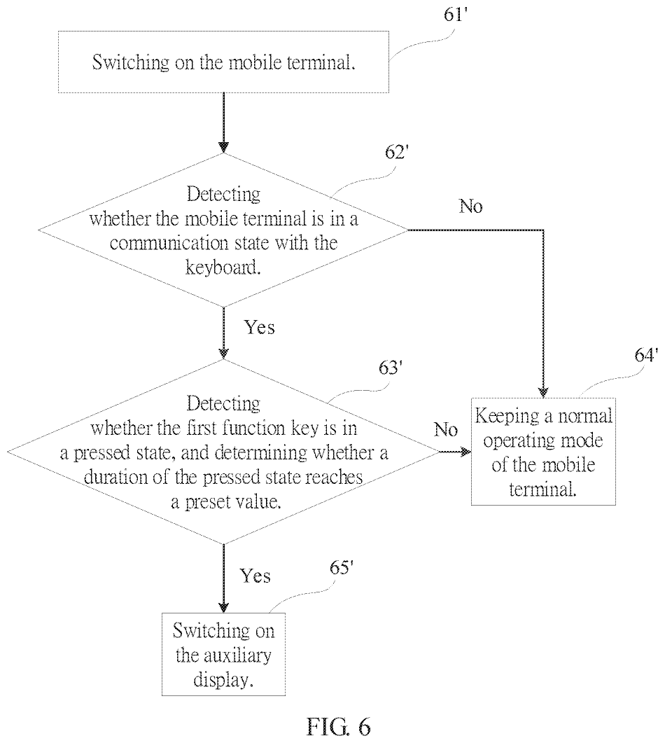

As shown in FIG. 6, a control method for the electronic device in the second embodiment includes the following:

The mobile terminal 10 is switched on, and detects the communication state between the mobile terminal 10 and the keyboard 30. When the two are in a communicationally disconnected state, a display mode of the mobile terminal is maintained. When the two are in a communicationally connected state, detection is performed as to whether duration for which the power switch 11 is in the triggered state reaches the preset value. When the preset value is not reached, a display mode of the mobile terminal is maintained. When the preset value is reached, the auxiliary display 40 on the back of the terminal 10 is switched on, and a screen of the main display is transferred to the auxiliary display 40.

A scenario of the communicationally disconnected state between the mobile terminal 10 and the keyboard 30 is to separate the mobile terminal 10 and the keyboard 30, and detach mobile terminal 10 from the protective sleeve 20. The auxiliary display 40 may be a display of electronic ink. An electronic ink display has real paper like display effect, which is more suitable for text reading. When reading text using the mobile terminal 10, a user can take the mobile terminal 10 out of the protective sleeve 20, then trigger the power switch 11 for duration of the triggered state reaching the preset value, thus to switch a screen of the main display to the auxiliary display 40, and may enable the forward page turning function, the backward page turning function, and the return function using other function keys on the side of the terminal 10.

Further, a window 22a is formed on the first rear cover 22 and arranged over the auxiliary display 40 to expose the entirety of the auxiliary display 40, so that the terminal 10 needs not to be detached from the protective sleeve 20 when a screen of the main display is transferred to the auxiliary display 40. Specifically, the protective sleeve 20 is closed, the communication port on the mobile terminal 10 is disconnected from the first thimble on the keyboard 30 while both of the mobile terminal 10 and the keyboard 30 are in the protective sleeve 20. When the power switch 11 is triggered for duration of the triggered state reaching the preset value, a screen of the main display screen is transferred to the auxiliary display 40. The mobile terminal 10 also has a sensor for detecting whether the mobile terminal 10 is closed in the protective sleeve 20. When the mobile terminal 10 is detected as being closed in the protective sleeve 20, the main display of the mobile terminal 10 is switched off.

The invention discloses an electronic device with an extensible display and a control method thereof, which may carry out synchronized display with the provision of an auxiliary display screen on the other side of the mobile terminal, and thus the electronic device is suitable for multi-user scenarios. Additionally, a specific display screen may be selected according to different display content of the mobile terminal so as to obtain a better display effect.

Even though the foregoing specific embodiments of the present disclosure are detailed in the above description, as is understood by persons skilled in the art, however, various modifications and improvements can be made unto the embodiments without departing from the principle and spirit of the present disclosure, and should be protected in the scope of the claimed invention.

1. An electronic device with an extensible display, comprising a mobile terminal, a protective sleeve, and a keyboard and an auxiliary display for communicating with the mobile terminal respectively, wherein the keyboard and the mobile terminal are arranged on the protective sleeve; the keyboard is provided with a first thimble which is operable to be inserted into a communication port of the mobile terminal when the mobile terminal is placed in a corresponding position on the keyboard, the protective sleeve comprises a front cover, a first rear cover, and a flexible part, wherein the flexible part is connected with the front cover and the first rear cover, the first rear cover is rotatable relative to the front cover, the keyboard is arranged on an inner surface of the front cover, the mobile terminal is arranged on a surface of the first rear cover facing the front cover, the auxiliary display is arranged on the back of the mobile terminal, a window is formed on the first rear cover, and the auxiliary display is arranged in the window.

2. The electronic device of claim 1, wherein the mobile terminal is equipped with a power switch used to switch on and off the auxiliary display.

3. The electronic device of claim 2, wherein the auxiliary display is arranged on a surface of the first rear cover facing away from the front cover.

4. An electronic device with an extensible display, comprising a mobile terminal, a protective sleeve, and a keyboard and an auxiliary display for communicating with the mobile terminal respectively, wherein the keyboard and the mobile terminal are arranged on the protective sleeve, and the auxiliary display is arranged on a side of the protective sleeve opposing to a main display of the mobile terminal.

5. The electronic device of claim 4, wherein the keyboard is provided with the first thimble which is operable to connect to the communication port of the mobile terminal.

6. The electronic device of claim 4, wherein the mobile terminal is equipped with a power switch used to switch on and off the auxiliary display.

7. The electronic device of claim 4, wherein the protective sleeve comprises a front cover, a first rear cover, and a flexible part, wherein the flexible part is connected with the front cover and the first rear cover, and the first rear cover is rotatable relative to the front cover, the keyboard is arranged on an inner surface of the front cover, and the mobile terminal is arranged on a surface of the first rear cover facing the front cover.

8. The electronic device of claim 7, wherein the auxiliary display is arranged on a surface of the first rear cover facing away from the front cover.

9. The electronic device of claim 7, wherein the auxiliary display is arranged on the back of the mobile terminal, and a window is formed on the first rear cover, and the auxiliary display is arranged in the window.

10. A control method for an electronic device with an extensible display, comprising:
detecting whether a mobile terminal is in a communication state with a keyboard; and
detecting whether a power switch is in a triggered state and determining whether duration of the triggered state reaches a preset value, and, when the duration reaches the preset value, selectively switching on or off an auxiliary display according to the detected communication state regarding the mobile terminal and the keyboard.

11. The control method of claim 10, wherein the detecting whether the mobile terminal is in the communication state with the keyboard further comprises:
detecting a signal level of a communication port on the mobile terminal, wherein if the signal level of the communication port is high, the mobile terminal is in a communicationally connected state with the keyboard.

12. The control method of claim 11, wherein the auxiliary display is electrically connected to the keyboard and is disposed on a protective sleeve, and the auxiliary display is switched on while the mobile terminal is detected as in the communicationally connected state with the keyboard, and when duration for which the power switch is in a triggered state is detected as reaching the preset value.

13. The control method of claim 11, wherein the auxiliary display is electrically connected with the mobile terminal and disposed on the back of the mobile terminal, and the auxiliary display is switched on while the mobile terminal is detected to be in a communicationally disconnected state with the keyboard, and when duration for which the power switch is in a triggered state is detected as reaching the preset value.

14. The electronic device of claim 1, wherein the auxiliary display is detachably connected with the mobile terminal.

15. The electronic device of claim 14, wherein the auxiliary display is detachably connected with the mobile terminal through the first rear cover.

16. The electronic device of claim 4, wherein the auxiliary display is detachably connected with the mobile terminal.

17. The electronic device of claim 16, wherein the auxiliary display is detachably connected with the mobile terminal through the first rear cover.

18. The control method of claim 11, wherein the auxiliary display is detachably connected with the mobile terminal.
